(19) United States
(12) Patent Application Publication
(10) Pub. No.: US 2019/0184663 A1
(43) Pub. Date: Jun. 20, 2019

(54) METHOD FOR MANUFACTURING TIRE COMPONENT MEMBER

(71) Applicant: Toyo Tire & Rubber Co., Ltd., Itami-shi (JP)

(72) Inventor: Ikutaro Yagi, Itami-shi (JP)

(73) Assignee: Toyo Tire & Rubber Co., Ltd., Itami-shi (JP)

(21) Appl. No.: 16/212,296

(22) Filed: Dec. 6, 2018

(30) Foreign Application Priority Data
Dec. 20, 2017 (JP) 2017-243628

(51) Int. Cl. B29D 30/30

(52) U.S. Cl. CPC B29D 30/30; B29D 2030/3064

(57) ABSTRACT

Test conditions including the number of windings of winding a ribbon rubber around a forming drum and a feed pitch for moving the ribbon rubber in an axial direction of the forming drum for each rotation of the forming drum are set, and a test sample is prepared under the test conditions. A thickness distribution in a width direction of the prepared test sample is measured, and the thickness distribution in the measured width direction is compared with the target shape to specify the ribbon rubber located at a portion in which a thickness deviation amount exceeds a predetermined range. Then, the feed pitch of the specified ribbon rubber is changed to prepare the tire component member.

### BACKGROUND OF THE INVENTION

### Field of the Invention

The present invention relates to a method for manufacturing a tire component member.

### Description of the Related Art

Generally, a pneumatic tire is manufactured by bonding a plurality of tire component members such as a tread rubber, a sidewall rubber, a carcass ply, a bead, a bead filler, a belt ply and the like on a forming drum to form a green tire, and then by setting the green tire in a mold for vulcanization molding. As a method for forming such a green tire, a ribbon winding method is known in which a strip-shaped ribbon rubber is wound around an outer peripheral surface of a forming drum while being moved in an axial direction of the forming drum, to form the tire component member such as the tread rubber (for example, see JP-A-2002-254531).

JP-A-2002-254531 discloses a method in which an average circumferential thickness in a circumferential direction of a forming drum of a ribbon rubber formed by winding the ribbon rubber is calculated, and winding conditions such as a moving distance (so-called feed pitch) for moving the ribbon rubber in the axial direction of the forming drum for each rotation of the forming drum and the number of windings of winding the ribbon rubber around the forming drum are calculated so that a distribution shape of a total added thickness obtained by total addition of the average circumferential thickness is substantially equal to a cross-sectional shape of the tire component member.

### SUMMARY OF THE INVENTION

However, even if the tire component member is formed under forming conditions calculated as in JP-A-2002-254531, the tire component member having a desired shape may not be obtained in some cases. Particularly when the ribbon rubber is wound around the forming drum while extruding the ribbon rubber from an extruder, since the ribbon rubber tends to be deformed, the tire component member having a desired shape may not be obtained from the calculated forming conditions. Therefore, skill and experience by a skilled operator are required in order to determine final forming conditions.

The present invention has been made in view of the above circumstances, and an object thereof is to provide a method for manufacturing the tire component member capable of forming the tire component member having a desired shape by the ribbon winding method without depending on skill and experience of the operators.

The method of manufacturing the tire component member of the present invention is a method for manufacturing a tire component member by winding a strip-shaped ribbon rubber around an outer peripheral surface of a forming drum while moving the ribbon rubber in an axial direction of the forming drum. The method of manufacturing the tire component member includes: a first step of setting test conditions including the number of windings of winding the ribbon rubber around the forming drum and a feed pitch for moving the ribbon rubber in the axial direction of the forming drum for each rotation of the forming drum, and a target shape of the tire component member; a second step of preparing the tire component member under the test conditions set in the first step; a third step of measuring a thickness distribution in a width direction of the tire component member prepared in the second step; a fourth step of comparing the measured thickness distribution in the width direction with the target shape to specify a ribbon rubber located at a portion in which a thickness deviation amount exceeds a predetermined range; and a fifth step of changing the feed pitch of the ribbon rubber specified in the fourth step to prepare the tire component member.

### BRIEF DESCRIPTION OF THE DRAWINGS

FIG. 1 is a view showing a configuration of an apparatus for manufacturing a tire component member according to an embodiment;

FIG. 2 is a flowchart showing a process of the apparatus for manufacturing the tire component member in FIG. 1.

FIG. 3 is a cross-sectional view of the tire component member; and

FIG. 4 is an enlarged cross-sectional view of a main part of the tire component member.

### DESCRIPTION OF THE PREFERRED EMBODIMENTS

An embodiment of the present invention will be described below with reference to the drawings.

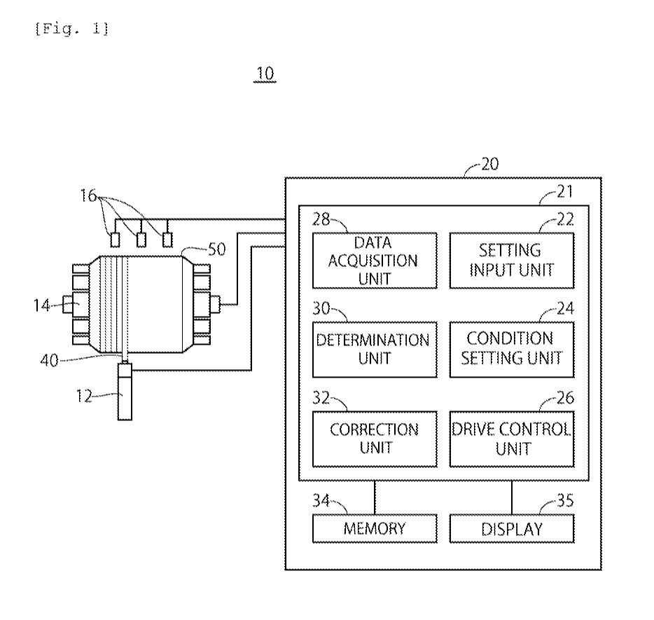

FIG. 1 shows an apparatus (hereinafter also referred to as a manufacturing apparatus) 10 for manufacturing a tire component member according to the present embodiment.

The manufacturing apparatus 10 includes a ribbon rubber supply unit 12, a forming drum 14, a shape sensor 16, and a control device 20. The manufacturing apparatus 10 manufactures a tire component member 50 on the forming drum 14 by a so-called ribbon winding method. In the present embodiment, as the tire component member 50, a case of forming a substantially cylindrical tread rubber which is provided in a tread portion of a pneumatic tire and constitutes a ground contact surface will be described, however, the present invention can also be applied to the manufacture of tire component members such as a sidewall rubber other than the tread rubber.

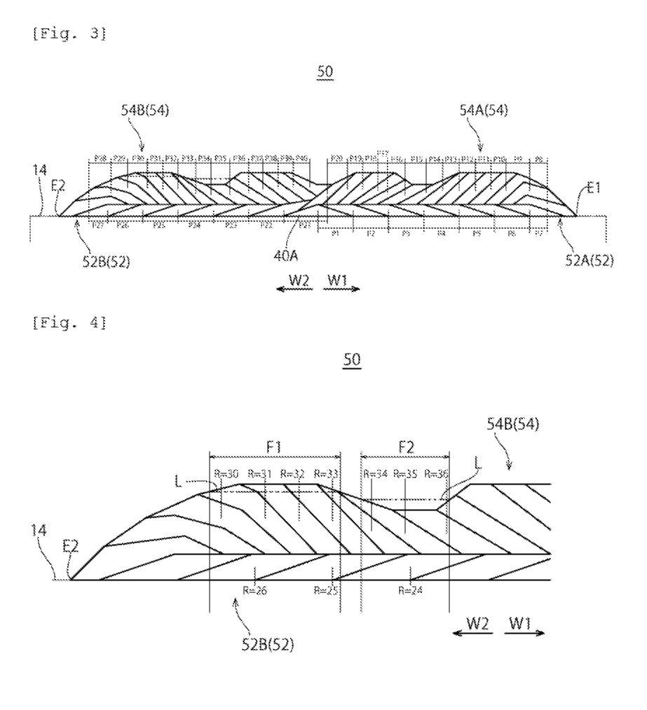

As shown in FIG. 3, the tire component member 50 includes an inner layer 52 composed of a first inner layer 52A and a second inner layer 52B, and an outer layer 54 composed of a first outer layer 54A and a second outer layer 54B laminated on the outer side of the inner layer 52.

The ribbon rubber supply unit 12 includes an extruder capable of extruding a ribbon rubber 40 into a predetermined cross-sectional shape, and supplies the ribbon rubber to the forming drum while extruding the ribbon rubber from the extruder. A cross-sectional shape of the ribbon rubber 40 is not particularly limited, and various shapes having a flat cross-sectional shape such as a trapezoidal shape, a crescent shape, a triangular shape, or the like can be adopted. A size of the ribbon rubber 40 is not particularly limited, but it can be, for example, 15 to 40 mm in width and 0.5 to 3.0 mm in thickness (thickness in the maximum thickness portion).

The forming drum 14 is configured so that it can rotate about a rotation axis and move in an axial direction (direction parallel to the rotation axis). If the forming drum 14 and the ribbon rubber supply unit 12 are relatively movable in the axial direction, the ribbon Lubber supply unit 12 may be configured to be movable in place of the forming drum 14.

The shape sensor 16 is a sensor for measuring an outer shape of the tire component member 50 formed on the forming drum 14, that is, a thickness distribution in a width direction of the tire component member 50, in a non-contact state on the forming drum 14. The width direction of the tire component member 50 is a direction which coincides with an axial direction of the forming drum 14 and is a direction corresponding to a width direction of the tire when constituting the tire together with other members.

The shape sensor 16 is the sensor for measuring the tire component member 50 in a non-contact state on the forming drum 14. For example, a laser displacement sensor for measuring a distance to a reflection surface by irradiating the tire component member 50 formed on the forming drum 14 with a laser beam can be used as the shape sensor 16. A width, a cross-sectional area, and the thickness distribution in the width direction of the tire component member are measured at a plurality of positions in a circumferential direction of the tire component member 50 at predetermined intervals, and a total value or an average of measurement results at each measurement point can be a measured value of the tire component member.

The control device 20 is constituted by a computer or a control microcomputer device including an arithmetic processing unit 21, a memory 34, and a display 35, and is connected to the ribbon rubber supply unit 12, the forming drum 14, and the shape sensor 16. The control device 20 controls an operation of the ribbon rubber supply unit 12, to supply an unvulcanized strip-shaped ribbon rubber 40 from the ribbon rubber supply unit 12 to the forming drum 14 while rotating the forming drum 14, so that the ribbon rubber 40 is wound around the forming drum 14 to form the tire component member 50.

Further, the arithmetic processing unit 21 includes a setting input unit 22, a condition setting unit 24, a drive control unit 26, a data acquisition unit 28, a determination unit 30, and a correction unit 32.

The setting input unit 22 is a unit to be input with various parameters such as the cross-sectional shape of the ribbon rubber 40 supplied from the ribbon rubber supply unit 12 to the forming drum 14, a target shape of a cross-section of the tire component member 50, a winding start position and a winding end position of the ribbon rubber 40, and a movement pattern of the forming drum 14, which are used for calculation of the number of windings R and a feed pitch P to be described later. The input various parameters are temporarily stored in the memory 34.

The condition setting unit 24 calculates the number of windings R of winding the ribbon rubber 40 around the forming drum 14 and a moving distance (the feed pitch) P for moving the ribbon rubber 40 in the axial direction of the forming drum 14 for each rotation of the forming drum based on the various parameters input by the setting input unit 22, and sets the calculated number of windings R and feed pitch P as test conditions. That is, when the number of windings R is N (N: integer, N=41 in FIG. 3) times, feed pitches Pn (n=1, 2, - - - N−1) are set for each turn of the ribbon rubber 40 wound 360 degrees from a winding start end of the ribbon rubber 40. The feed pitch P is set to be smaller than the width of the ribbon rubber 40 and the ribbon rubber 40 is wound so that at least a part thereof overlaps the adjacent ribbon rubbers 40 in the width direction.

The number of windings R and the feed pitch P for each turn obtained by the condition setting unit 24 are input to the drive control unit 26 together with the winding start position and the winding end position of the ribbon rubber 40 and the movement pattern of the forming drum 14. The number of windings R and the feed pitch P for each turn obtained by the condition setting unit 24 are stored in the memory 34.

The drive control unit 26 controls the operation of the ribbon rubber supply unit 12 and the forming drum 14 based on data input from the condition setting unit 24 and the correction unit 32 to prepare the tire component member 50 and its test sample on the forming drum 14.

In the case illustrated in FIG. 3, the ribbon rubber 40 is wound from a winding start end 40A positioned at the center in the width direction of the forming drum 14 to the eighth turn toward one side W1 in the width direction of the tire to form the first inner layer 52A. Further, the ribbon rubber 40 is turned back at an end E1 on one end side of the forming drum 14 and wound from the ninth turn to the center (21th turn) in the width direction of the tire toward the other side W2 in the width direction of the tire to form the first outer layer 54A. Further, the ribbon rubber 40 is continued to be wound to the 28th turn toward the other side W2 in the width direction of the tire to form the second inner layer 52B. Furthermore, the ribbon rubber 40 is turned back at an end E2 on the other side of the forming drum 14 and wound from the 29th turn to the center (41th turn) in the width direction of the tire toward the one side W1 in the width direction of the tire to form the second outer layer 54B. That is, in the case of FIG. 3, the first inner layer 52A is formed by the ribbon rubber 40 from the first to eighth turns, the first outer layer 54A is formed by the ribbon rubber 40 from the ninth to 21th turns, the second inner layer 52B is formed by the ribbon rubber 40 from the 22nd to 28th turns, and the second outer layer 54B is formed by the ribbon rubber 40 from the 29th to 41th turns.

The data acquisition unit 28 receives a displacement signal (a signal indicating a distance from the sensor to the reflection surface) from the shape sensor 16 and acquires data on a shape of the test sample formed on the forming drum 14, specifically data on a thickness distribution (an outline shape) in a width direction of the test sample. The acquired data is temporarily stored in the memory 34.

The determination unit 30 reads the data on the thickness distribution in the width direction of the test sample stored in the memory 34 and determines whether the test sample prepared under the test conditions is in the target shape, that is, compares the thickness distributions in the width direction between the test sample prepared under the test conditions and the target shape and determines whether a deviation amount between them is within a predetermined range.

The determination unit 30 determines whether the test sample is in the target shape, that is, compares the thickness distribution in the width direction of the measured test, sample and the target shape and determines whether a thickness deviation amount is within the predetermined range. When there is a portion in which the thickness deviation amount exceeds the predetermined range, the ribbon rubber 40 located at the portion is specified. That is, it is specified which turn of the ribbon rubber 40 is located at the portion in which the thickness deviation amount exceeds the predetermined range Then, the determination unit 30 inputs the result to the correction unit 32.

The correction unit 32 determines forming conditions of the tire component member 50 to be prepared next based on an input from the determination unit 30, and inputs the forming conditions to the drive control unit 26. A method of determining the forming conditions of the tire component member 50 to be prepared next will be described later.

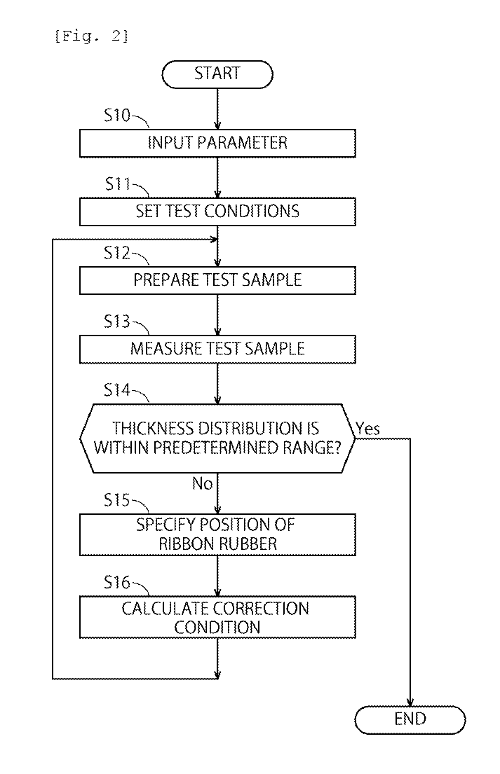

Next, a process flow according to the present embodiment will be described with reference to FIG. 2.

First, the various parameters such as the cross-sectional shape of the ribbon rubber 40 supplied from the ribbon rubber supply unit 12 to the forming drum 14, and the target shape of the cross-section of the tire component member 50, which are used for calculation of the number of windings R and the feed pitch P, are input to the setting input unit 22 (Step S10).

Next, the condition setting unit 24 calculates the number of windings R and the feed pitch P depending on the target shape based on the various parameters input to the setting input unit 22, and acquires the test conditions (Step S11).

Next, the drive control unit 26 controls the operation of the ribbon rubber supply unit 12 and the forming drum 14 based on the test conditions calculated by the condition setting unit 24, and prepares the test sample of the tire component member 50 on the forming drum 14 (Step S12).

Next, the shape sensor 16 measures the width, the cross-sectional area, and the thickness distribution in the width direction of the test sample of the tire component member 50 prepared on the forming drum 14, and the data acquisition unit 28 acquires the measurement results (Step S13).

Next, the determination unit 30 compares the thickness distributions in the width direction between the test sample prepared under the test conditions and the target shape, and determines whether the thickness deviation amount is within the predetermined range (Step S14). Then, when there is the portion in which the thickness deviation amount exceeds the predetermined range (No in Step S14), the ribbon rubber 40 located at the portion in which the thickness deviation amount exceeds the predetermined range is specified (Step S15).

For example, as exemplified in FIG. 4, when a thickness of the test sample exceeds the predetermined range with respect to an outer diameter line L of the target shape in a region F1, and the thickness falls below the predetermined range with respect to the outer diameter line L of the target shape in a region F2, the ribbon rubber 40 at the 25th, 26th, and 30th to 33rd turns from the winding start end 40A is specified as the ribbon rubber 40 located at positions in which the thickness is excessive, and the ribbon rubber 40 at the 24th, and 34th to 36th turns from the winding start end 40A is specified as the ribbon rubber 40 located at positions in which the thickness is insufficient.

When the determination unit 30 specifies the portion in which the thickness deviation amount exceeds the predetermined range, the correction unit 32 adjusts the feed pitch P of the ribbon rubber 40 at the specified position to calculate a correction condition (Step S16). As a method of calculating the correction condition in this case, the feed pitch P of the ribbon rubber 40 at the position in which the thickness is insufficient is reduced, and the feed pitch P of the ribbon rubber 40 at the position in which the thickness is excessive is increased. An amount of change in the feed pitch P can be changed depending on a deviation of the thickness between the test sample and the target shape.

When the correction unit 32 calculates the correction condition in Step S16, the process returns to Step S12 again, and the drive control unit 26 controls the operation of the ribbon rubber supply unit 12 and the forming drum 14 based on the correction condition calculated by the correction unit 32 to prepare a second test sample of the tire component member 50 on the forming drum 14.

Thereafter, preparation (Step S12), measurement (Step S13), evaluation (Steps S14, S15) of the test sample, and calculation of the correction condition (Step S16) are repeated until the deviation amount of the thickness distribution in the width direction between the test sample and the target shape falls within the predetermined range. When the deviation amount of the thickness distribution in the width direction between the test sample and the target shape is within the predetermined range (Yes in Step S14), the correcting unit 32 determines that the prepared test sample is in the target shape, and sets the test conditions or the correction condition without modification, so that the tire component member 50 is manufactured under this condition.

According to the present embodiment, it is possible to obtain the tire component member 50 by winding the ribbon rubber around the outer peripheral surface of the forming drum while moving the ribbon rubber in the axial direction of the forming drum without requiring skill and experience by a skilled operator.

Further, in the present embodiment, since the width, the cross-sectional area, and the thickness distribution in the width direction of the test sample of the tire component member 50 formed on the forming drum 14 are measured in a non-contact state, it is possible to accurately measure the test sample without deformation during the measurement.

The above embodiment is presented as an example and is not intended to limit the scope of the invention. This novel embodiment can be implemented in various other forms and various omissions, substitutions, and changes can be made without departing from the gist of the invention.

For example, in the present embodiment, a description is given of a case where the ribbon rubber 40 is directly wound around the outer peripheral surface of the forming drum 14 to prepare the test sample of the tire component member 50. However, for example, the test sample of the tire component member 50 may be provided on another tire component member already provided on the outer peripheral surface of the forming drum 14. In this case, the shape of the outer peripheral surface of the forming drum 14 is measured before preparing the test sample of the tire component member 50, and a difference between the measurement result after the test sample is prepared and the measurement result before the test sample is prepared may be used as a measured value.

In the present embodiment, the number of windings R and the feed pitch P calculated by the condition setting unit 24 based on the various parameters input by the setting input unit 22 are set as the test conditions, however, conditions directly input by the operator may be set as the test conditions, or previously used conditions may be set as the test conditions.

Further, in the present embodiment, a description has been given of a case where when there is the portion in which the thickness deviation amount exceeds the predetermined range between the test sample prepared under the test conditions by the determination unit 30 and the target shape, the correction unit 32 newly calculates the correction condition. However, for example, when the determination unit 30 specifies the ribbon rubber 40 located at a position in which the thickness of the test sample exceeds or falls below the predetermined range with respect to the target shape, the position and the deviation amount of the specified ribbon rubber 40 may be displayed on the display 35 to urge the operator to correct the test, conditions and the condition directly input by the operator may be used as the correction condition.

### DESCRIPTION OF REFERENCE NUMERALS AND SIGNS

10: manufacturing apparatus, 12: ribbon rubber supply unit, 14: forming drum, 16: shape sensor, 20: control device, 21: arithmetic processing unit, 22: setting input unit, 24: condition setting unit, 26: drive control unit, 23: data acquisition unit, 30: determination unit, 32: correction unit, 34: memory, 35: display, 40: ribbon rubber, 50: tire component member, 52: inner layer, 54: outer layer.

What is claimed is:

1. A method for manufacturing a tire component member by winding a strip-shaped ribbon rubber around an outer peripheral surface of a forming drum while moving the ribbon rubber in an axial direction of the forming drum, comprising:
a first step of setting test conditions including the number of windings of winding the ribbon rubber around the forming drum and a feed pitch for moving the ribbon rubber in the axial direction of the forming drum for each rotation of the forming drum, and a target shape of the tire component member;
a second step of preparing the tire component member under the test conditions set in the first step;
a third step of measuring a thickness distribution in a width direction of the tire component member prepared in the second step;
a fourth step of comparing the measured thickness distribution in the width direction with the target shape to specify a ribbon rubber located at a portion in which a thickness deviation amount exceeds a predetermined range; and
a fifth step of changing the feed pitch of the ribbon rubber specified in the fourth step to prepare the tire component member.

2. The method for manufacturing the tire component member according to claim 1, wherein the thickness distribution in the width direction of the tire component member prepared in the second step is measured in a non-contact state on the forming drum in the third step.
